(19) United States
(12) Patent Application Publication
(10) Pub. No.: US 2004/0236559 A1
(43) Pub. Date: Nov. 25, 2004

(54) Statistical approach for power estimation

(76) Inventor: Thomas W. Chen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/444,826

(22) Filed: May 23, 2003

(51) Int. Cl. G06F 17/50

(52) U.S. Cl. 703/18

(57) ABSTRACT

An indication of power associated with one or more power consuming units of is determined based on simulation data. The simulation data can be generated over a plurality of testcases. A Bayesian-based statistical model utilizes the simulation data to estimate a parameter indicative of power associated with the one or more power consuming units. A corresponding indication of power is computed based on the estimated parameter.

### TECHNICAL FIELD

The present invention relates to circuit analysis and, more particularly, to a statistical approach for estimating power consumption.

### BACKGROUND OF INVENTION

Power consumption is becoming an increasing concern in the design of integrated circuits (ICs), particularly for very large scale integration (VLSI) chip designs. To address this concern, many computer-aided design (CAD) tools have been developed to measure or estimate power consumption in VLSI designs. The estimated power consumption is employed to help designers meet target power parameters and ultimately facilitate design convergence.

Techniques used to estimate switching activities associated with power consumption in VLSI chips can be divided into two general groups: simulation-based techniques and statistics-based techniques. For both types of techniques, the dynamic power consumption of a circuit is computed based on estimated switching activities of a circuit or a defined part of a circuit. In particular, power consumption is proportional to the switching activities and the associated capacitance at respective nodes of the circuit.

For power estimation, existing simulation-based approaches tend to be highly dependent on the input patterns (or input vectors) used to stimulate the circuit model. That is, the power estimation tool usually requires input patterns designed specifically for power estimation. Additionally, specialized power estimation simulations or CAD tools are often utilized to estimate power consumption.

Statistics-based approaches to power estimation can often achieve improved performance over simulation-based approaches because statistical inference can be performed based on a smaller amount of simulation data. Thus, statistics-based techniques can circumvent the need for prohibitively expensive simulations to cover a large input space in the simulation based techniques. However, most statistics based techniques may not be as accurate as actual simulations due to their inability to consider certain types of power consumption associated, such as associated with structural and operating glitches that may occur during actual simulation.

In view of such potential limitations, more recent statistical approaches tend to rely heavily on Monte-Carlo simulations to estimate overall power. Such Monte-Carlo related approaches, however, usually require power-related simulation vectors that are representative of a specific set of power characteristics of the unit under design. Typically, these techniques also treat average and maximum power estimation differently, such that separate simulations are performed for average and maximum power.

### SUMMARY OF INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some general concepts of the invention in a simplified form as a prelude to the more detailed description that is presented later.

The present invention relates generally to a system and method to estimate power consumption. One aspect of the present invention provides a system that employs a statistical model (e.g., a Bayesian model) to estimate at least one parameter indicative of power associated with at least one power consuming unit based on simulation data. Estimated power is computed based on the estimated at least one parameter. The unit, for example, can be a node, a circuit component, a functional or structural block or a combination thereof.

Another aspect of the present invention provides a power estimation system that includes a power estimator that employs a Bayesian model to determine an indication of power for one or more units of a circuit design based on simulation data generated over a plurality of testcases. The simulation data for each of the plurality of testcases describes activity of the one or more units of the circuit design, such as according a plurality of input vectors designed to exercise at least a portion the circuit design.

Yet another aspect of the present invention provides a method for estimating power for a circuit design. The method includes accessing simulation data generated for the circuit design based on at least one set of input vectors that defines a testcase. A Bayesian model is employed to estimate an indication of power for at least one unit of the circuit based on the simulation data generated over a plurality of testcases. The method, for example, can be implemented in hardware, software or a combination thereof.

### BRIEF DESCRIPTION OF THE DRAWINGS

FIG. 1 depicts a simplified block diagram of a power estimation system implemented in accordance with an aspect of the present invention.

FIG. 2 depicts an example of a power estimation system implemented in accordance with an aspect of the present invention.

FIG. 3 is a graph of illustrating mean power estimated for a plurality of samples.

FIG. 4 is a graph illustrating standard deviation for power estimated for a plurality of samples.

FIG. 5 is a graph of illustrating mean power estimated for a plurality of samples having a reduced data set.

FIG. 6 is a graph illustrating standard deviation for power estimated for a plurality of samples having a reduced data set.

FIG. 7 depicts an example of a moving average Bayesian approach that can be implemented to estimate power in accordance with an aspect of the present invention.

FIG. 8 is a graph of illustrating mean power estimated based on a moving average of samples.

FIG. 9 is a graph illustrating standard deviation for power estimated based on a moving average of samples.

FIG. 10 depicts an example of an asymptotic Bayesian approach that can be implemented to estimate power in accordance with an aspect of the present invention.

FIG. 11 is a graph of illustrating mean power estimated for a plurality of samples.

FIG. 12 is a graph illustrating standard deviation for power estimated for a plurality of samples.

FIG. 13 is a graph of illustrating mean power estimated for a plurality of samples having a reduced data set.

FIG. 14 is a graph illustrating standard deviation for power estimated for a plurality of samples having a reduced data set.

FIG. 15 depicts a power estimation system for plural circuit units implemented in accordance with an aspect of the present invention.

FIG. 16 is a flow diagram illustrating a methodology for estimating power in accordance with an aspect of the present invention.

### DETAILED DESCRIPTION

The present invention relates generally to a system and method that can be utilized to estimate power (e.g., associated with a circuit). The estimated power, which can include average power and/or maximum power, can be determined for one or more units by employing a Bayesian model relative to simulation data associated with a plurality of testcases. For example, in a circuit design, a given unit can correspond to a node or other juncture between adjacent components, structures or blocks, as well as a circuit component, a functional or structural block, or any combination thereof.

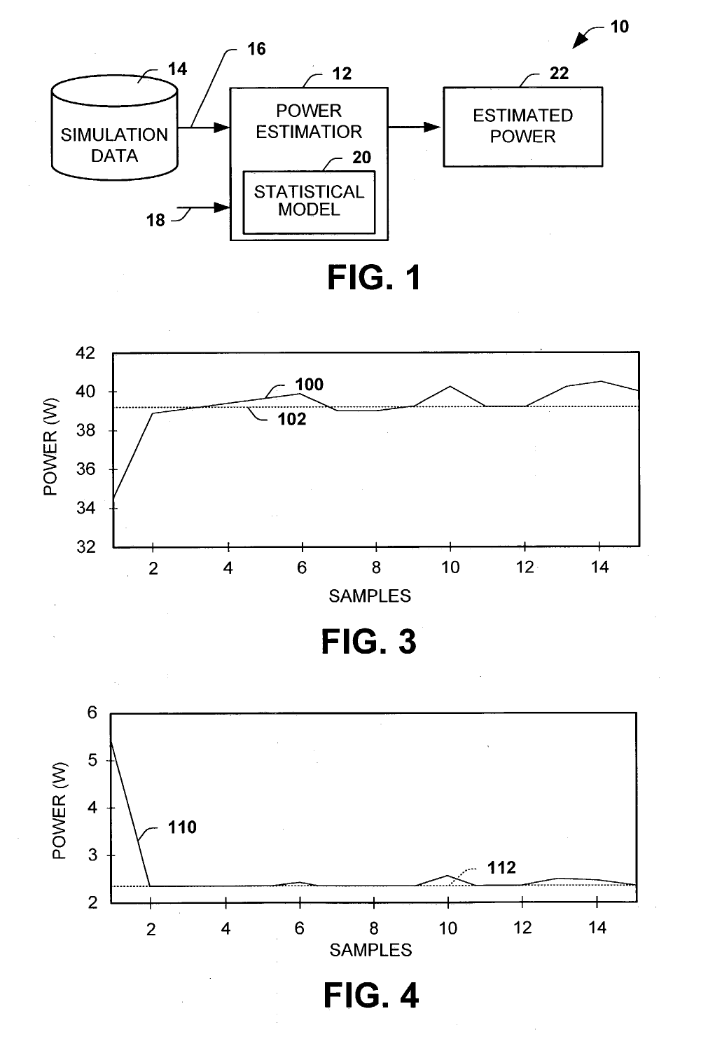

FIG. 1 illustrates a system 10 that can be implemented to estimate power in accordance with an aspect of the present invention. The system 10 includes a power estimator 12 that performs power estimation based on simulation data 14, corresponding to simulation results for one or more testcases. Each testcase includes a collection of input patterns or vectors designed to exercise at least a particular portion or unit of a circuit design. The simulation data 14 can be generated by performing actual simulation on a given circuit structure (e.g., an integrated circuit or chip), such as to test structural and/or functional operation of the circuit. Alternatively, the simulation data can be generated by a computer-implemented simulation run on a model that represents the circuit design or a selected portion thereof. At least some of the simulation data 14 provides information 16 associated with power consumption of the circuit design or a portion thereof (referred to herein as “power-related information”). The power estimator 12 performs the power estimation based on the power-related information 16 generated over a plurality of testcases.

It is desirable to estimate power consumption early in the design flow to facilitate meeting target power parameters and to facilitate design convergence. Accordingly, the simulation data can be generated based on simulation for a high-level model or description for a given circuit design, such as a register transfer level (RTL) model, a gate-level model and the like. For example, the simulation data 14 can be generated by performing functional verification on a RTL model that represents the circuit design. A higher level model, such as a RTL model utilized for functional verification or other types of functional or structural simulation, generally can implement simulations more rapidly than lower-level simulations for the same circuit design.

Various commercially available CAD tools (e.g., available from Synopsis, Avant, Cadence or others) as well as proprietary tools can be employed to derive the corresponding power-related information 16. These tools employ input patterns or vectors to simulate and verify the correctness (or detect design flaws) of the circuit design. Various types of simulation, including timing and signal analysis, functional verification, and physical verification, are routinely implemented on various types of integrated circuits to confirm expected performance prior to mass production.

For more complex circuit designs, simulations are typically performed for a large number of testcases throughout a substantial portion of the design process to mitigate functional flaws in the circuit being designed. Each testcase can include a set of one or more input vectors or patterns, usually on the order of about 10³ to 10⁴ patterns. For example, greater than 50% of the design cycle can be consumed by functional verification, resulting in an abundance of data that can be used for power estimation implemented according to an aspect of the present invention. Examples of circuits functionally tested in this manner include processors (e.g., central processing unit (CPU) chips and microprocessors), application specific integrated circuits (ASICs), or other similarly complicated VLSI (Very Large Scale Integration).

By way of further example, functional verification can provide various types of information indicative of operating behavior characteristics associated with the circuit design. One subset of functional verification corresponds to the power-related information 16, such as information that characterizes switching characteristics of respective units of the circuit design for a given testcase. For example, functional verification can be utilized to generate an activity factor for nodes or junctures located between functional or structural blocks in the circuit model. The activity factor corresponds to a toggle count of switching activity for a node normalized over a number of clock cycles. Similar types of power related information can be obtained from other types of simulations.

The power-related information 16 can be obtained from memory, such as stored as an associated database or other data structure, as depicted in FIG. 1. Alternatively, power-related information, indicated at 18, can be provided to the power estimator 12 during the simulation process, such that the simulation and power estimation can occur concurrently in parallel. In either case, the source of the power-related information can be located local (e.g., same computer or other tool) or remote (e.g., different computer or tool connected via network or by other communications infrastructure) relative to the power estimator 12. For purposes of clarity, the following discussion will refer to the power-related information using reference number 16, although it is to be understood that the information could include the information 16, 18 or both.

The power estimator 12 includes a statistical model 20 that is updated based on the information 16 provided for a plurality of testcases. The statistical model is programmed and/or configured to estimate one or more parameters related to power, which parameter(s) maps to an associated distribution. For example, the model estimates the one or more parameters for a plurality of units of the circuit design associated with the simulation data 14. As described herein, each unit can correspond to a node, a collection of nodes, or a functional block, a structural block, or other logical grouping of circuit components or structures. The particular type of units generally depends on the type of circuit description or model simulated to generate the simulation data. In one particular implementation, the units can be nodes of an RTL model.

The statistical model 20 can be updated to improve the power estimation over number of testcases. For example, the model 20 can be updated over a set of N testcases, where N is a positive integer, which can be fixed or variable. Where N is variable, it should be sufficient to cause the estimated model parameters to converge to within an acceptable level. The convergence of the model can be evaluated, for example, by fitting the estimates relative to an asymptotic curve taken as N approaches infinity (e.g., by applying least squares estimates or other regression analysis), which can be implemented over a number of testcases. Convergence further can be facilitated by employing a sorting algorithm to arrange the simulation data for a number of testcases.

By way of example, where the circuit design is represented to include a plurality of nodes or other structural junctures between associated structural or functional blocks, the model 20 parameterizes one or more parameters associated with behavioral operating characteristics (e.g., the switching activity factor) for respective units in the design. According to an aspect of the present invention, the model 20 is implemented as a Bayesian model that estimates parameters based on the power-related information 16. The power estimator 12 employs the estimated parameters to compute estimated power 22 for the circuit design or a portion of the design.

The use of a Bayesian model facilitates a determination of both average and maximum power (corresponding to the estimated power 22) by the power estimator 12 based on estimated model parameters. For example, the model 20 can estimate the a pair of related parameters concurrently based on common simulation data generated over a plurality of testcases, such that separate sets of testcases are not required for determining the average and maximum power. In particular, the model 20 provides mean and standard deviation estimates for respective units of the circuit design. The power estimator 12 employs the updated mean and standard deviation estimates provided by the model to compute corresponding mean and standard deviation unit power estimates. The power estimator 12 in turn aggregates the respective mean unit power estimates to provide a total average power estimate. The estimator 12 also aggregates the estimated standard deviation unit power to provide a total estimated standard deviation for the average power. The total standard deviation estimate can then be added to the total average power estimate to provide a corresponding total maximum power estimate.

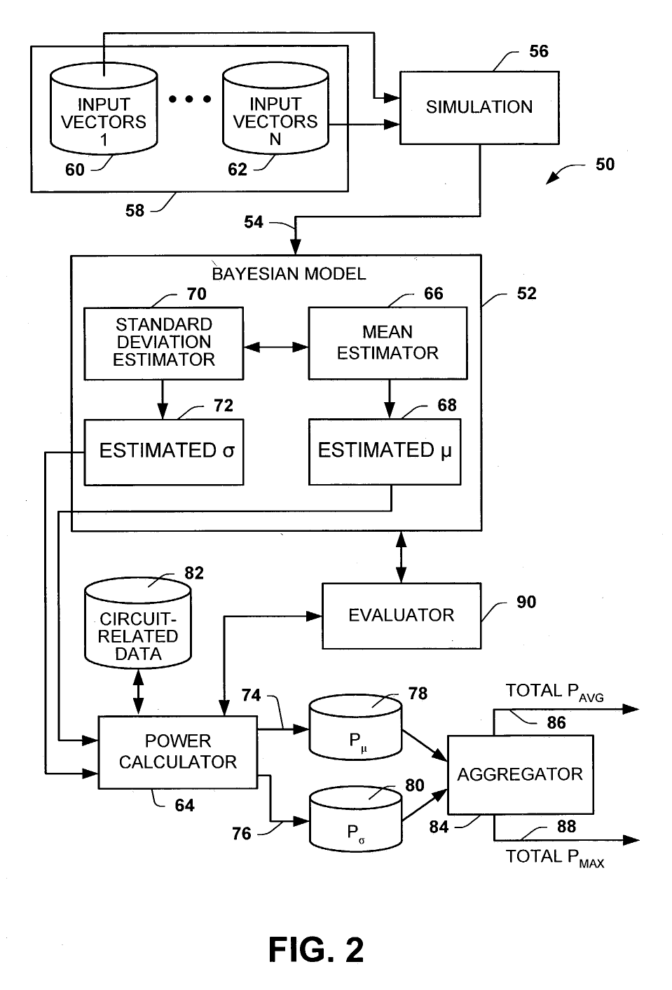

FIG. 2 is an example of a power estimation system 50 that can be implemented in accordance with an aspect of the present invention. The system 50 includes a Bayesian model 52 that is programmed and/or configured to estimate one or more parameters related to power consumption. The model 52 estimates the switching activities based on information 54 generated by simulation 56, such as information related to power consumption of one or more units of a circuit. The simulation information 54 can be obtained from an associated memory device (not shown) directly or via a communications infrastructure, or be provided directly to the power estimation system 50 by the simulation 56.

The simulation 56 can include hardware and/or software programmed to verify one or more structural or functional features of a circuit design represented by a circuit model (not shown). The circuit model, for example, can represent high-level architectural or structural properties of the circuit design, such as a RTL model. The simulation 56 generates the power-related information 54 based on a plurality of testcases 58. Each of the testcases 58 includes an associated set of input vectors 60-62, represented as INPUT VECTORS 1 through INPUT VECTORS N, where N denotes the number of testcases. Each set of input vectors 60, 62 corresponds to a testcase that is employed to stimulate or exercise activity of the circuit model for verifying one or more selected structural or functional features of the circuit design. A given set of input vectors, for example, can be utilized to verify any type of function for a selected part of the circuit design, including control logic, memory, registers, cache, latches and buffers. Each set of input vectors 60-62 in the testcases 58 can be randomly generated or designed specifically to test a particular functional or structural part of the design.

As mentioned above, the simulation 56 can employ various techniques to generate the power-related information 54. The power related information 54 can be indicative of behavioral operating characteristics (e.g., switching activities, signal activities) and/or electrical operating characteristics (e.g., voltage, current, component values), or other characteristics of the circuit design for which the simulation is being implemented. In one particular implementation, the power-related information 54 can include information indicative of node-level switching activities for the circuit design, such as provided by functional verification simulation. The node level switching activity can be employed to derive the activity factor for corresponding nodes. It is to be appreciated that the simulation 56 can be implemented remotely and the power-related information 54 obtained by the power estimation system 50 via a network or other type of communications link.

According to one type of implementation, the simulation 56 corresponds to functional verification implemented on input testcases 58 designed to verify functional operation of the circuit design, and not specifically developed for power estimation purposes. By employing a type of simulation 56 not designed for power estimation (e.g., functional verification), additional efficiencies can be realized with the system 50, as neither additional power simulations nor specialized input vectors are required. Additionally, those skilled in the art will appreciate that functional verification is routinely utilized throughout the design process (e.g., often occupying greater than 50% of the design process) for many types of integrated circuits to ensure proper functional operation of the circuit, thus often providing extremely large numbers of testcases. Accordingly, functional verification information provides valid input space for employing the Bayesian model 52 for parameter estimation.

The Bayesian model 52 is implemented to estimate parameters associated with a distribution formed of the power-related information 54 over the plurality of testcases 58. According to one example, model 52 estimates the mean and standard deviation for node-level switching activities of the circuit model (e.g., RTL model) obtained through the simulation 56, and updates parameters over the plurality of testcases. As a greater number of testcases are utilized, the estimated mean provided by the Bayesian model 52 tends to converge or saturate to an associated value, an average value. The Bayesian model 52 provides the resulting estimated mean and standard deviation values for respective circuit units to a power calculator 64 for computing estimated power consumption. The estimated power for a plurality of respective units of the circuit design further can be summed to provide total power for these units.

By way of example, the Bayesian model 52 includes a mean estimator 66, such as a Bayesian estimator, programmed and/or configured to provide an estimated mean parameter 68, such an activity factor, based on switching activity information derived from the power-related information 54 over plural testcases. During the Bayesian estimation process, the estimator 66 utilizes the functional verification 52 associated with different testcases to update the model parameters and provide a new estimated mean 68. The Bayesian model 52 also includes a standard deviation estimator 70 that is operative to compute an estimated standard deviation 72 for the activity factor. The standard deviation, for example, is determined as a function of the estimated mean 68. The estimators 66 and 70, for example, estimate the mean 68 and standard deviation 72 for respective units of the circuit, such as for one or more selected nodes of the circuit. Accordingly, the circuit can be divided into units that are independently verified, and the power estimation system 50 be applied by decomposing the model (e.g., into corresponding sub-models) to estimate average and maximum power for each respective unit.

By way of further example, the Bayesian model 52 can be implemented by assuming the average power consumption of a certain unit of a chip is a random variable distributed as a normal function with certain mean and standard deviation. One can apply n testcases to the simulation 56 that generates the power-related information 54 to enable the power estimation system 50 to estimate the statistics of the unit power consumptions and observe n power values for each unit, \vec{p}=pᵢ for i=1 . . . n. Each data point pᵢ is a sample from the assumed distribution function of the average power of the unit. The samples \vec{p} can have the same normal distribution function with either the same mean and standard deviation values or different mean and different standard deviation values. The following example assumes a general case where the mean and standard deviation values of each observation are different, but they obey the normal distribution function.

In view of the above assumptions and nomenclature, let P be a random variable representing the average power consumption of a given unit in a chip. Let P be normally distributed with unknown mean μ and unknown standard deviation σ. Thus,

$$P ∼ fp ( p ) = \frac{1}{\sqrt{2 πσ}} {ⅇ}^{\frac{\_ {( p - μ )}^{2}}{2 {σ}^{2}}} \qquad Eq . 1$$

In this example, assume the samples from the normal distribution function of Eq. 1 have different parameters μ, σ but the same normal function. In this case, these parameters can be represented as:

μ=μᵢ=μ₀gᵢ, for i=1 . . . n and Eq. 2

σ=σᵢ=σ₀uᵢ, for i=1 . . . n Eq. 3

where: μ₀ and σ₀ are fixed (but unknown) for all samples, and

gᵢ and uᵢ are arbitrary functions controlled by the statistics of the input testcases i=1 . . . n.

Based on the set testcases \vec{p} (e.g., each testcase pᵢ providing power-related information 54), the likelihood function of μ₀ and σ₀ can be measured assuming they are the a priori random variables, as follows:

$$\begin{matrix}L ( {μ}_{0} {σ}_{0} \vert \vec{p} ) = {\prod }_{i = 1}^{n} fp ( {p}_{i} \vert {μ}_{0} , {σ}_{0} ) & Eq . 4 \\ = {\prod }_{i = 1}^{n} \frac{1}{\sqrt{2 {π}_{i}} {σ}_{0} μ} {ⅇ}^{- \frac{{( {p}_{i} - {μ}_{0 gi} )}^{2}}{2 {σ}_{0}^{2} {μ}_{i}^{2}}} & Eq . 5 \\ = {( \frac{1}{\sqrt{2 π}} )}^{n} ( \frac{1}{{\prod }_{i}^{n} = 1 {μ}_{i}^{2}} ) \\ \frac{1}{{σ}_{0}^{n}} {ⅇ}^{- \frac{t}{2 {σ}_{0}^{2}} {\sum }_{i = 1}^{n} {( \frac{{p}_{i} - {μ}_{0} {g}_{i}}{{μ}_{i}} )}^{2}} & Eq . 6 \\ = {( \frac{1}{\sqrt{2 π}} )}^{n} ( \frac{1}{{\prod }_{i}^{n} = 1 {μ}_{I}^{2}} ) \\ \frac{1}{{σ}_{0}^{n}} {ⅇ}^{- \frac{t}{2 {σ}_{0}^{2}} ( {\sum }_{i = 1}^{n} \frac{{p}_{i}^{2}}{{μ}_{i}^{2}} + {μ}_{0}^{2} {\sum }_{i = 1}^{n} \frac{{g}_{i}^{2}}{{μ}_{i}^{2}} - 2 {μ}_{0} {\sum }_{i = 1}^{n} \frac{{p}_{i} {g}_{i}}{{μ}_{i}^{2}} )} & Eq . 7\end{matrix}$$

For simplification, the following quantities can be abbreviated, as follows:

$$\begin{matrix}{M}_{n} = \frac{1}{n} {\sum }_{i = 1}^{n} \frac{{p}_{i}^{2}}{{μ}_{i}^{2}} & Eq . 8 \\ {G}_{n} = \frac{1}{n} {\sum }_{i = 1}^{n} \frac{{g}_{i}^{2}}{{μ}_{i}^{2}} & Eq . 9 \\ {Q}_{n} = \frac{1}{n} {\sum }_{i = 1}^{n} \frac{{p}_{i} {g}_{i}}{{μ}_{i}^{2}} & Eq . 10 \\ {U}_{n} = {( \frac{1}{\sqrt{2 π}} )}^{n} {\prod }_{i - 1}^{n} \frac{1}{{u}_{i}} & Eq . 11\end{matrix}$$

In a situation where it can be assumed that all testcases have similar statistics, when gᵢ=1 and uᵢ=1 for all input testcases i=1 . . . n. For purposes of brevity and simplification, the following example assumes such similar statistics exist. From Eqs. 8-11, we have Mₙ=s²+\overline{X}², Gₙ=1 and Qₙ=\overline{X}, which corresponds to a simple type of Bayesian model where all samples are from the same distribution. Substituting these terms in the likelihood function of Eq. 7 provides:

$$\begin{matrix}L ( {μ}_{0} , {σ}_{0} \vert \vec{p} ) = {U}_{n} \frac{1}{σ \frac{n}{0}} {ⅇ}^{- \frac{1}{2 {σ}_{0}^{2}} ( {nM}_{n} + n {μ}_{0}^{2} {G}_{n} - 2 n {μ}_{o} {Q}_{n} )} & Eq . 12 \\ = {U}_{n} \frac{1}{{σ}_{0}^{n}} {ⅇ}^{- \frac{n}{2 {σ}_{0}^{2}} ( {G}_{n} {μ}_{0}^{2} - 2 {Q}_{n} {μ}_{0} + {M}_{n} )} & Eq . 13\end{matrix}$$

To simplify the Bayesian calculations for σ₀, the standard deviation can be represented by:

$$ζ = \frac{1}{{σ}_{0}^{2}} \qquad Eq . 14$$

Assume μ₀ and ζ are independent with the following priori distribution functions:

$$\begin{matrix}{μ}_{0} ∼ φ ( v , {τ}^{2} ) = \frac{1}{\sqrt{2 π r} τ} {ⅇ}^{- \frac{{( {μ}_{0} - v )}^{2}}{2 {τ}^{2}}} & Eq . 15 \\ \begin{matrix}ζ ∼ Γ ( γ , r ) = \frac{{γ}^{r}}{Γ ( r )} {ζ}^{r - 1} {ⅇ}^{- γζ} & ζ > 0\end{matrix} & Eq . 16\end{matrix}$$

From the likelihood and priori distribution functions, the Bayesian estimates of the parameters μ₀ and ζ can be calculated given n testcases that were applied and yielded n data points \vec{p}. Since independency is assumed, the Bayesian estimates of μ₀ and ζ can be calculated independently.

For purposes of the following example, let \hat{μ}₀ be the Bayesian estimate of μ₀, and \hat{ζ} be the Bayesian estimate of ζ. By applying Bayesian rules, the Bayesian estimate of μ₀ can be expressed as follows:

$$\begin{matrix}E ( {μ}_{0} \vert \vec{p} ) = {\int }_{- ∞}^{∞} {μ}_{0} L ( {μ}_{0} \vert \vec{p} ) {f}_{M} ( {μ}_{0} ) ⅆ {μ}_{0} & Eq . 17 \\ = \frac{{\int }_{- ∞}^{∞} {μ}_{0} {U}_{n} \frac{1}{{σ}_{0}^{n}} {ⅇ}^{- \frac{n}{2 σ \frac{2}{0}} ( {G}_{n} {μ}_{0}^{2} - 2 {Q}_{n} {μ}_{0} + {M}_{n} )} \frac{1}{\sqrt{2 π} τ} {ⅇ}^{- \frac{{( {μ}_{0} - v )}^{2}}{2 {τ}^{2}}} ⅆ {μ}_{0}}{{\int }_{- ∞}^{∞} {U}_{n} \frac{1}{{σ}_{0}^{n}} {ⅇ}^{- \frac{n}{2 σ \frac{2}{0}} ( {G}_{n} {μ}_{0}^{2} - 2 {Q}_{n} {μ}_{0} + {M}_{n} )} \frac{1}{\sqrt{2 π} τ} {ⅇ}^{- \frac{{( {μ}_{0} - v )}^{2}}{2 {τ}^{2}}} ⅆ {μ}_{0}} & Eq . 18 \\ = \frac{{\int }_{- ∞}^{∞} {μ}_{0} {ⅇ}^{- \frac{n}{2 {σ}_{0}^{2}} ( {G}_{n} {μ}_{0}^{2} - 2 {Q}_{n} {μ}_{0} + {M}_{n} )} {ⅇ}^{- \frac{{( {μ}_{0} - v )}^{2}}{2 {τ}^{2}}} ⅆ {μ}_{0}}{{\int }_{- ∞}^{∞} {ⅇ}^{- \frac{n}{2 σ \frac{2}{0}} ( {G}_{n} {μ}_{0}^{2} - 2 {Q}_{n} {μ}_{0} + {M}_{n} )} {ⅇ}^{- \frac{{( {μ}_{0} - v )}^{2}}{2 {τ}^{2}}} ⅆ {μ}_{0}} & Eq . 19\end{matrix}$$

The numerator and denominator of Eq. 19 can be formed as integrals of a normal distribution function with respect to μ₀ by multiplying the integrals by some constants. Therefore, the common exponent term of Eq. 19 can be rewritten in the form:

$${ⅇ}^{- \frac{{( {μ}_{0} - \hat{μ} )}^{2}}{2 {s}^{2}}} \qquad Eq . 20$$

where the Bayesian estimate of μ₀ becomes:

$$E ( {μ}_{0} \vert \vec{p} ) \frac{{\int }_{- ∞}^{∞} {μ}_{0} φ ( {μ}_{0} , {s}^{2} ) ⅆ {μ}_{0}}{{\int }_{- ∞}^{∞} φ ( {μ}_{0 ,} {s}^{2} ) ⅆ {μ}_{0}} = \frac{{μ}_{0}}{1} = {μ}_{0} \qquad Eq . 21$$

The power of the exponent term of Eq. 19 is therefore:

$$\begin{matrix}\begin{matrix}- \frac{{( {μ}_{0} - {\hat{μ}}_{0} )}^{2}}{2 {s}^{2}} = - \frac{n}{2 {σ}_{0}^{2}} ( {G}_{n} {μ}_{0}^{2} - 2 {Q}_{n} {μ}_{0} + {M}_{n} ) - \\ \frac{1}{2 {τ}^{2}} {( {μ}_{0} - v )}^{2}\end{matrix} & Eq . 22 \\ \begin{matrix} = - \frac{1}{2 {σ}_{0}^{2} {τ}^{2}} [ n {τ}^{2} {G}_{n} {μ}_{0}^{2} - 2 n {τ}^{2} {Q}_{n} {μ}_{0} + n {τ}^{2} {M}_{n} + \\ {σ}_{0}^{2} {μ}_{0}^{2} + {σ}_{0}^{2} {v}^{2} - 2 {σ}_{0}^{2} v {μ}_{0} ]\end{matrix} & Eq . 23 \\ \begin{matrix} = - \frac{1}{2 {σ}_{0}^{2} {τ}^{2}} [ ( n {τ}^{2} {G}_{n} + {σ}_{0}^{2} ) {μ}_{0}^{2} - 2 ( n {τ}^{2} {Q}_{n} + {σ}_{0}^{2} v ) \\ {μ}_{0} + ( n {τ}^{2} {M}_{n} + {σ}_{0}^{2} {v}^{2} ) ]\end{matrix} & Eq . 24 \\ = - \frac{n {τ}^{2} {G}_{n} + {σ}_{0}^{2}}{2 {σ}_{0}^{2} {τ}^{2}} \\ [ {μ}_{0}^{2} - 2 \frac{n {τ}^{2} {Q}_{n} + {σ}_{0}^{2} v}{n {τ}^{2} {G}_{n} + {σ}_{0}^{2}} {μ}_{0} + \frac{n {τ}^{2} {M}_{n} + {σ}_{0}^{2} {v}^{2}}{n {τ}^{2} {G}_{n} + {σ}_{0}^{2}} ] & Eq . 25\end{matrix}$$

To form a complete square factor of the quadratic term of μ₀ from Eq. 25, the square of half the coefficient of μ₀ can be added and then subtracted back. In the integral, this addition in the exponent will be a multiplication by a constant on both the numerator and denominator, which will not affect the estimation. The exponent term will then become:

$$- \frac{{( {μ}_{0} - {\hat{μ}}_{0} )}^{2}}{2 {s}^{2}} = - {\frac{n {τ}^{2} {G}_{n} + {σ}_{0}^{2}}{2 {σ}_{0}^{2} {τ}^{2}} [ {μ}_{0} - \frac{n {τ}^{2} {Q}_{n} + {σ}_{0}^{2} v}{n {τ}^{2} {G}_{n} + {σ}_{0}^{2}} ]}^{2} + K \qquad Eq . 26$$

where K is an adjusting constant employed to the complete square factor.

Therefore, the Bayesian estimated mean \hat{μ}₀ (e.g., corresponding to the estimated mean 68) is:

$${\hat{μ}}_{0} = \frac{n {τ}^{2} {Q}_{n} + {σ}_{0}^{2} v}{n {τ}^{2} {G}_{n} + {σ}_{0}^{2}} \qquad Eq . 27$$

The Bayesian estimate of ζ (e.g., functionally related to the estimated standard deviation 72 through Eq. 14) given the history testcase data \vec{p} can similarly be calculated, as follows:

$$\begin{matrix}E ( ζ \vert \vec{p} ) = \frac{{\int }_{0}^{∞} ζ L ( ζ \vert \vec{p} ) f z ( ζ ) ⅆ ζ}{{\int }_{0}^{∞} L ( ζ \vert \vec{p} ) f z ( ζ ) ⅆ ζ} & Eq . 28 \\ = \frac{{\int }_{0}^{∞} ζ {U}_{n} \frac{1}{{σ}_{0}^{n}} {ⅇ}^{- \frac{n}{2 {σ}_{0}^{2}} ( {G}_{n} {μ}_{0}^{2} - 2 {Q}_{u} {μ}_{0} + {M}_{n} )} \frac{{γ}^{r}}{Γ ( r )} {ζ}^{r - 1} {ⅇ}^{- γ ζ} ⅆ ζ}{{\int }_{0}^{∞} {U}_{n} \frac{1}{{σ}_{0}^{n}} {ⅇ}^{- \frac{n}{2 {σ}_{0}^{2}} ( {G}_{n} {μ}_{0}^{2} - 2 {Q}_{u} {μ}_{0} + {M}_{n} )} \frac{{γ}^{r}}{Γ ( r )} {ζ}^{r - 1} {ⅇ}^{- γ ζ} ⅆ ζ} & Eq . 29 \\ = \frac{{\int }_{0}^{∞} {ζζ}^{\frac{n}{2} + r - 1} {ⅇ}^{- \frac{n}{2} ζ ( {G}_{n} {μ}_{0}^{2} - 2 {Q}_{n} {μ}_{0} + {M}_{n} ) - γ ζ} ⅆ ζ}{{\int }_{0}^{∞} {ζ}^{\frac{n}{2} + r - 1} {ⅇ}^{- \frac{n}{2} ς ( {G}_{n} {μ}_{0}^{2} - 2 {Q}_{n} {μ}_{0} + {M}_{n} ) - γ ζ} ⅆ ζ} & Eq . 30\end{matrix}$$

Similarly, Eq. 30 can be formed as integrals of a Gamma distribution function with updated parameters r and γ. Thus, the updated parameters can be expressed as:

$$\begin{matrix}{r}^{+} = \frac{n}{2} + r & Eq . 31 \\ {γ}^{+} = \frac{n}{2} ( {G}_{n} {μ}_{0}^{2} - 2 {Q}_{n} {μ}_{0} + {M}_{n} ) + γ & Eq . 32\end{matrix}$$

Therefore, the Bayesian expectation of ζ is the expected value of Gamma function:

$$\hat{ζ} = \frac{{r}^{+}}{{γ}^{+}} = \frac{\frac{n}{2} + r}{\frac{n}{2} ( {G}_{n} {μ}_{0}^{2} - 2 {Q}_{n} {μ}_{0} + {M}_{n} ) + γ} \qquad Eq . 33$$

where γ and r are the initial guess parameters for ζ or σ. By way of further example, if an initial guess for the standard deviation σ is chosen to be 1, then γ and r can both be selected to approach zero. Therefore, the Bayesian estimate of ζ becomes:

$$\hat{ζ} = \frac{1}{{G}_{n} {μ}_{0}^{2} - 2 {Q}_{n} {μ}_{0} + {M}_{n}} \qquad Eq . 34$$

Utilizing Eqs. 15 and 35, the Bayesian estimate of the standard deviation σ₀ (indicated at 72 in FIG. 2) can be determined from the variance as follows:

σ₀²=Gₙμ₀²−2Qₙμ₀+Mₙ Eq. 35

Since \hat{μ}₀ and \hat{σ}₀ are functionally related to each other, Eqs. 35 and 27 can be utilized (by substituting Eq. 35 into Eq. 27) to solve for \hat{μ}₀, which provides:

$${μ}_{0} = \frac{n {τ}^{2} {Q}_{n} + ( {G}_{n} {μ}_{0}^{2} - 2 {Q}_{n} {μ}_{0} + {M}_{n} ) v}{n {τ}^{2} {G}_{n} + ( {G}_{n} {μ}_{0}^{2} - 2 {Q}_{n} {μ}_{0} + {M}_{n} )} \qquad Eq . 36$$

which can be expanded as:

(nτ²Gₙ+Gₙμ₀²−2Qₙμ₀+Mₙ)μ₀=nτ²Qₙ+(Gₙμ₀²−2Qₙμ₀+Mₙ)ν Eq. 38

Factorizing Eq. 38 as a polynomial function of μ₀, provides a third order polynomial equation with respect to μ₀, as follows:

(Gₙ)μ₀³−(νGₙ+2Qₙ)μ₀²+(2νQₙ+nτ²Gₙ+Mₙ)μ₀−(νMₙ+nτ²Qₙ)=0 Eq. 39

Thus, Eq. 39 can be solved for real values of μ₀>0 (e.g., either numerically or analytically) and obtain the Bayesian estimated standard deviation \hat{σ}₀.

Referring back to FIG. 2, the Bayesian estimated mean 68 and standard deviation 72, which can be computed as described above, are provided to the power calculator 64. The power calculator 64 computes a mean unit power estimate (P_{μ}) 74 and a standard deviation unit power estimate (P_{σ}) 76, respectively represented (for purposes or illustration) at 78 and 80. The power calculator 64 performs such computations based on the estimated mean 68, the estimated standard deviation 72 and other circuit-related data 82. The circuit-related data 82 includes additional information about structural and operating characteristics for the circuit design on which the simulation 56 is performed. Such information can be obtained from the associated circuit model (e.g., a RTL model or other hardware description language (HDL) model) being tested by the simulation 56.

The dynamic power consumption of a circuit is proportional to the switching activities of signals in the circuit and the associated capacitance at those signal nodes. By way of example, the estimated mean 68 corresponds to node-level switching activities, such as the node-level activity factor (AF), and the estimated standard deviation 66 are standard deviation estimates associated with the respective estimated mean 68 for respective nodes. The circuit-related data 82, for example, includes a load capacitance (C_{LOAD}), chip supply voltage (V_{DD}), and chip clock frequency (f_{clk}) for each respective node in the corresponding circuit design. It is to be appreciated that V_{DD} and f_{clk} are typically fixed for a given chip and that C_{LOAD} can be readily determined from the RTL or other level description of the circuit design. Thus, the power calculator 64 can compute power (P) for each node (or other unit) as follows:

P=AF*V_{DD}²*C_{LOAD}*f_{CLK} Eq. 40

For example, the power calculator 64 can employ Eq. 40 to compute the mean unit power estimates (P_{μ}) 74 and the standard deviation unit power estimates (P_{σ}) based on the mean and standard deviation 68 and 72 estimate determined by the model 52 for respective units of the circuit.

The system 50 also include an aggregator 84 operative to aggregate or sum the respective computed power calculations 78 and 80 to provide a total estimated average power P_{AVG}, indicated at 86. Additionally, the aggregator 84 can be utilized to calculate a total estimated maximum power P_{MAX}, indicated at 88. The maximum power P_{MAX} can be computed as a function of the total estimated average power P_{AVG} and the total standard deviation power. The total standard deviation power, which is proportional to a total one-sigma standard deviation power (e.g., a one-sigma or higher-sigma standard deviation power), can be computed according to a desired confidence level. For example, a three-sigma standard deviation power usually is sufficient for use in computing total maximum power for a chip or one or more units thereof. The three-sigma standard deviation power (or other value proportional to the one-sigma standard deviation power) is added to the total estimated average power P_{AVG} to yield a value indicative of the total estimated maximum power P_{MAX} for the circuit design or a portion thereof. It is to be appreciated that higher sigma values (e.g., four-sigma, five-sigma, six-sigma, etc.) can also be utilized to determine maximum power where a higher confidence level is desired for P_{MAX}.

Additionally, where the circuit design has been decomposed into functional or structural units, the estimated average and maximum power 86 and 88 determined for each functional or structural unit further can be utilized to optimize the design process, such as in the case where one or more functional units may consume an amount of power outside acceptable operating parameters.

The power estimation system 50 can also include an evaluator 90 that can be utilized to control the number of iterations implemented by the statistical model 52. In one implementation, the model evaluator 90 can evaluate the total estimated average power 86 over a plurality of testcases to ascertain whether the average power has adequately saturated or converged to within a predetermined threshold of a power level. Adequate convergence, for example, can be ascertained by observing an asymptotic behavior of the estimated power, which corresponds to the average power as n→∞. Once the total estimated average power 86 has adequately converged, the power estimation system 50 provides substantially accurate average and maximum power values.

Alternatively or additionally, the evaluator 90 can evaluate the Bayesian model 52 for some or all estimated parameters 68 and 72 based on predetermined convergence criteria. For example, the model evaluator 90 can evaluate mean activity factor values estimated for a plurality of nodes to ascertain whether the activity factors for a sufficient sample of such nodes have converged or saturated to respective values. Once adequate conversion is observed, the power calculator 64 can compute corresponding power estimates 74 and 76 based on the updated mean and standard deviation estimates 68 and 72.

Those skilled in the art will understand and appreciate that the foregoing approach employing the Bayesian model 52 enables both average and maximum power to be computed concurrently by a single statistical model based on common sets of input vectors 60-62. The input vectors further can be designed to verify non-power related operating characteristics of the circuit, such as function or signaling of a given circuit design. Consequently, because the estimation process may be implemented more efficiently than other processes, such as those that require generation of specialized input vectors for computing different types of power characterizations. For example, efficiencies can be achieved by utilizing functional verification testcase to both verify operation of the circuit and to generate the input space for the Bayesian model 52.

FIGS. 3 and 4 are graphs depicting estimated mean and standard deviation of total chip power that were ascertained using a Bayesian model according to an aspect of the present invention. For each of the examples of FIGS. 3 and 4, fifteen testcases were utilized to implement the Bayesian process for estimating the mean and standard deviation parameters from which corresponding power was computed. It is to be appreciated that typically a greater number of testcases are utilized, which would result in substantial increased accuracy. The testcases associated with each of the data points were sufficiently large (e.g., consisting of tens of thousands of cycles) so that the testcases collectively present a broad spectrum of switching profiles in the circuit design.

In FIG. 3, power is plotted as a function of the samples (e.g., testcases) utilized as data points to implement the Bayesian estimation process and associated power calculations. In particular, FIG. 3 depicts a total estimated mean power 100 as well as a simple average estimated power 102. From FIG. 3, it is shown that the estimation for the mean value 100 can, at times, be higher than the simple average estimation 102 by approximately 3.5%. In particular, the estimated mean power 100 ranges generally from about 38.9 Watts (W) to about 40.7 W, with an average of about 39.62 W over the fifteen depicted testcases. A simple averaging method for estimating the average power provided an average estimation 352 of about 39.3 W.

Turning to FIG. 4, standard deviation power is plotted as a function of samples (e.g., testcases) as determined by employing a Bayesian estimation process and a simple average method, indicated at 110 and 112, respectively. As shown in FIG. 4, the Bayesian estimated standard deviation 110 provides an increase in the power estimation when compared to the standard deviation 112 for the simple averaging method for the same samples. In particular, the Bayesian model estimates the standard deviation on the average chip power to be about σ=2.6 W, whereas the simple average method provides σ=3.3 W. Overall, a Bayesian model implemented in accordance with an aspect of the present invention estimated the standard deviation to be in the range from about 2.3 to about 2.6. The results of a general Bayesian model are dependent on the initial guess utilized from among the data points in the sample data. Thus, additional improvements in the estimation could be realized by selecting the initial guess more carefully, such as based on a number of data points or on empirical studies with the circuit design or prior generation chips. As mentioned above, the estimated standard deviation can be utilized (e.g., by an aggregator or power calculator) to obtain a worst case or a maximum power consumption for a given design.

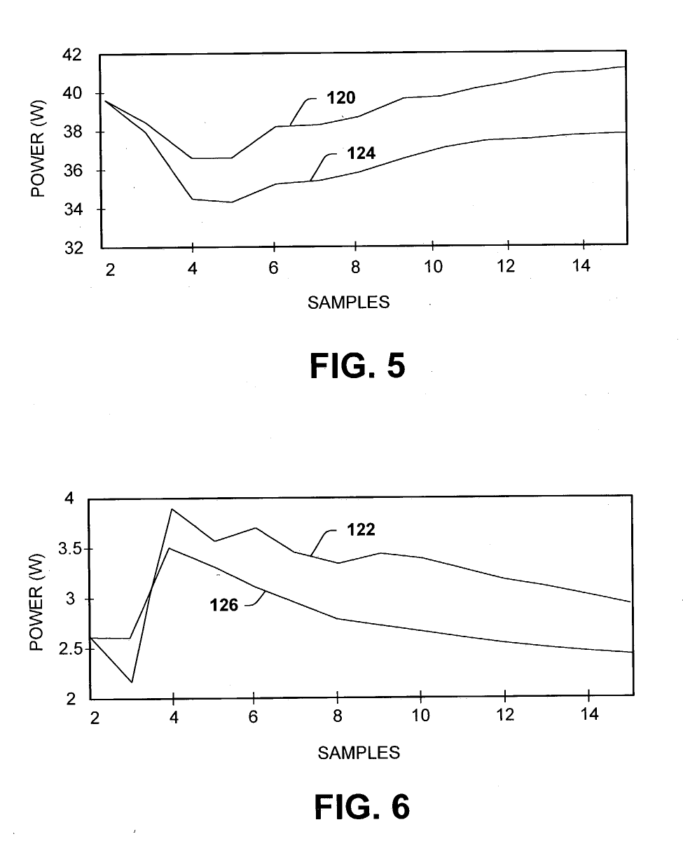

FIGS. 5 and 6 illustrate additional examples in which a Bayesian model has been implemented to estimate mean and standard deviation for power consumption for a given circuit design. In the examples of FIG. 5 and 6, fewer data sets were utilized than the examples described above with respect to FIGS. 3 and 4. In particular, FIG. 5 depicts the estimated mean power 120 and FIG. 6 depicts the estimated standard deviation 122 that were estimated with the same Bayesian model, although for fewer data sets than the examples depicted in FIG. 3 and 4. Also depicted in FIG. 5 and 6, for purposes of comparison, are moving average estimates for the average power, indicated at 124 in FIG. 5, and the moving average standard deviation, indicated at 126 in FIG. 6.

By way of further comparison, a chip corresponding to the examples of FIGS. 3-6 had an average power measure of about 42 W based on actual experimental simulation results. Thus, those skilled in the art will appreciate that Bayesian estimation, which can be implemented in accordance with an aspect of the present invention, provides a closer approximations to the actual average power consumption than simple averaging or moving averaging statistics on like data sets.

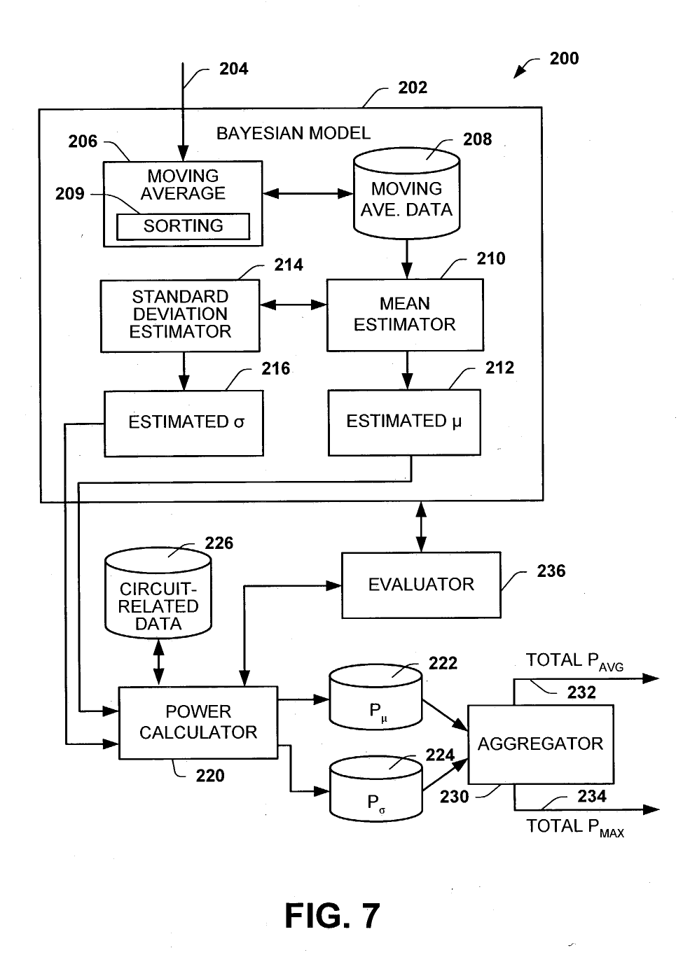

FIG. 7 illustrates another power estimation system 200 that can be implemented in accordance with an aspect of the present invention. The approach in FIG. 7 is similar to the approach shown and described with respect of FIG. 2 in that a Bayesian model 202 is utilized to facilitate substantially accurate power estimation.

The power estimation system 200 receives circuit activity information 204 over plural respective testcases, at least a portion of which information 204 relates to power consumption for a given circuit design. The power-related information 204 can correspond to any data indicative of switching activities for various units of a circuit, which can be generated according to any of the approaches shown and described herein. For example, functional verification implemented throughout the design process for numerous testcases provides an effective input space that can be used to ascertain node-level activity factors for the respective testcases. Advantageously, because functional verification is routinely implemented for a wide range of testcases usually having a plurality of input vectors, neither specialized input vectors nor power-specific simulations are required. Those skilled in the art will understand and appreciate other simulation techniques that can be utilized to generate suitable power-related information 204.

In the example of FIG. 7, the power estimation system 200 includes a moving average function 206 that is operative to convert the power-related data 204 to corresponding moving average data 208. The moving average function 206 can be employed to derive a more accurate initial guess for the Bayesian model 202, such as based on actual testcases.

By way of example, assume the power-related data 204 corresponds to switching activity data obtained for a plurality of testcases. The moving average function 206 computes a mean value of the average switching activity information for the first K testcases, where K is a positive integer greater than or equal to 1. The value of K can be selected based on the number of expected testcases. A higher value for K generally will facilitate convergence of the estimation performed by the Bayesian model 202.

By way of further example, let X be a random variable having a normal distributed function with mean g and standard deviation σ. The moving average of X given n testcases can defined as:

$${V}_{n} = \frac{1}{n} {\sum }_{j = 1}^{n} {X}_{j} \qquad Eq . 41$$

It can be shown that a moment generating function of the moving average V further maps to a normal distribution function having mean value μ and standard deviation σ.

Because the data 208 provided by the moving average function 206 can be order dependent, a sorting function 209 can be associated with the moving average function. The sorting function 209 is applied to arrange the power-related data for at least some of the testcases in a desired order. In this way, large fluctuations in the power-related information 204 over plural testcases can be mitigated, which may further facilitate convergence of the estimation produced by the Bayesian model 202.

The Bayesian model 202 and the remainder of the power estimation system 200 can be implemented in a manner similar to that shown and described with respect to FIG. 2. Briefly stated, Bayesian model 202 includes a mean estimator 210 that employs Bayesian methods to determine an estimated mean 212 based on the moving average power-related data 208 over a plurality of testcases. A standard deviation estimator 214 derives a corresponding estimated standard deviation 216 based on the estimate mean values 212. The Bayesian model 202 thus provides the resulting estimated mean 212 and standard deviation 216, for example, corresponding to the switching activities, such as activity factors for respective units.

A power calculator 220 computes estimated average and maximum powers 222 and 224, respectively, based on the Bayesian estimates 212 and 216 and based on associated circuit-related data 226. For example, the circuit-related data 226 includes parameters (e.g., C_{LOAD}, V_{DD}, and f_{clk}) to enable the power calculator 220 to determine unit power estimates (e.g., according to Eq. 40) based on respective Bayesian estimates 212 and 216 for respective units of the circuit design.

An aggregator 230 provides a total average power 232 and a total maximum power 234 for the circuit design or for a particular portion thereof. The aggregator 230 computes the total average power 232, for example, by summing the mean unit power estimates 222, as provided by the power calculator 220. The aggregator 230 similarly determines the total maximum power 234 by summing the standard deviation unit power estimates 224 (e.g., for respective nodes) and adding the total standard deviation power to the total average power 232.

The power estimation system 200 can also include an evaluator 236, which can control the estimation process. The evaluator 236 can evaluate the total estimated average power 232 over a plurality of testcases to ascertain whether the average power has adequately saturated or converged to within a predetermined threshold of its infinite saturation level. Alternatively or additionally, the evaluator 236 can be implemented to evaluate convergence of the parameters estimated by the Bayesian model 202. Once adequate conversion is reached for a sufficient sample of the estimate mean values, the power calculator 220 can compute the average power estimates 222, 224. Those skilled in the art will appreciate other techniques that can be employed to evaluate or score the parameters estimated by the power estimation system 200.

As mentioned above, the foregoing approach to power estimation enables both average and maximum (e.g., worst case) for a common set of input vectors. Additionally, it will be appreciated that, given a sufficient number of testcases, this approach can estimate power for a circuit or a portion of a circuit to a desirable level of accuracy even if the testcases are designed to verify to test a characteristic of the circuit other than power.

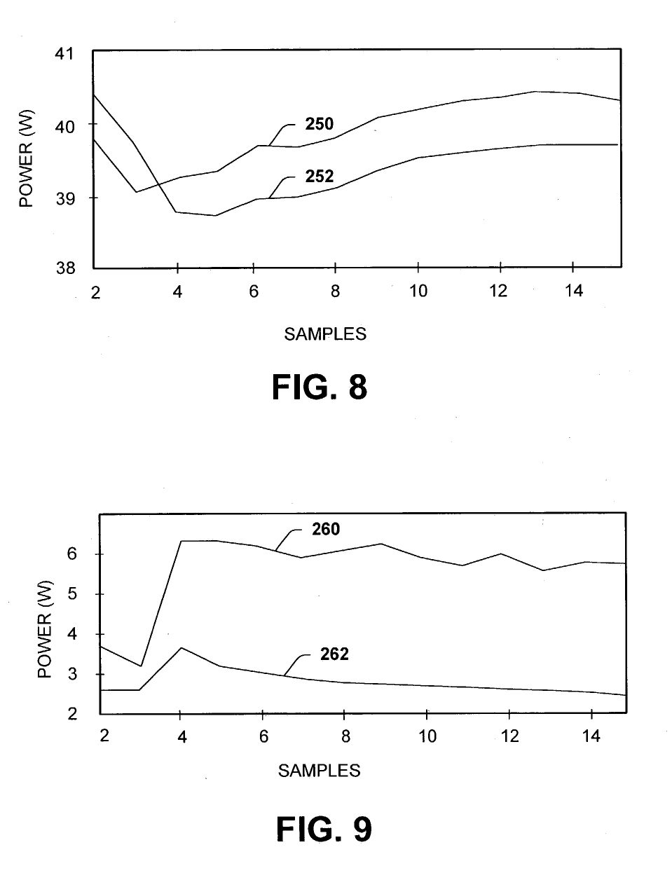

FIGS. 8 and 9 illustrate examples of mean and standard deviation power that can be estimated using moving average Bayesian power estimation, such as the system 200 of FIG. 7. In the examples of FIG. 8 and 9, similar to the examples of FIGS. 3-6, fifteen testcases were utilized to generate the respective graphs.

FIG. 8 depicts estimated mean power, indicated at 250, as a function of samples (e.g., testcases) computed employing a moving average Bayesian model according to an aspect of the present invention. The initial guess for the Bayesian estimation process in this example was manually chosen to be about 39 W. Also depicted in FIG. 8 is a simple moving average estimate of mean power, indicated at 252. From FIG. 8, it is shown that the Bayesian estimated mean power 250 is higher than the simple moving average 252 over a substantial part of the testcases. By way of further example, when fifteen testcases are utilized as the history data, the resulting estimated mean chip power 250 is equal to about 40.4 W.

FIG. 9 depicts power as a function of sample testcases illustrating the standard deviation based on a Bayesian power estimation approach employing a moving average according to an aspect of the present invention, indicated at 260. FIG. 9 also illustrates a standard deviation power estimates generated by employing a simple moving average, indicated at 262. The fifteen samples utilized to derive the standard deviation 260 provide a substantially high standard deviation equal to approximately 5.9 W. This is to be contrasted with the simple moving average approach that provided a lower standard deviation 262 of about 3.2 W.

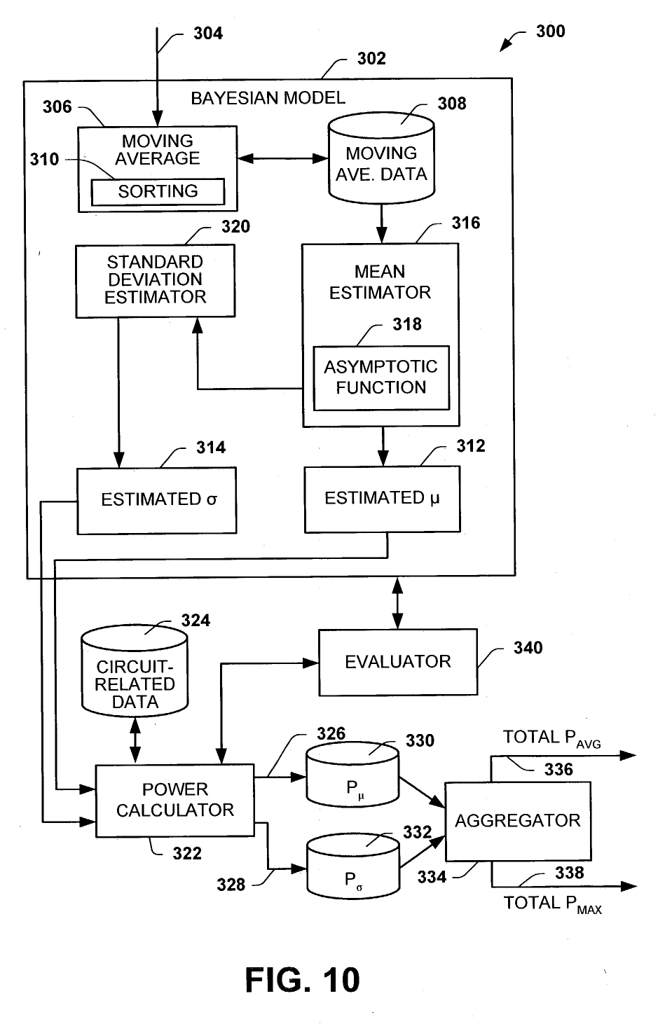

FIG. 10 illustrates yet another example of a power estimation system 300 that can be utilized to estimate power in accordance with an aspect of the present invention. The approach is similar to that shown and described in FIG. 7 in that it employs moving average Bayesian estimation.

The system 300 in the example of FIG. 10 includes an asymptotic Bayesian model 302 that estimates one or more power-related parameters based on simulation information 304. As described herein, the power-related data 304 can be derived from simulation on plural testcases and can correspond to switching activity information associated with one or more units of a circuit design on which the simulation is being performed.

The model 302 includes a moving average function 306 that converts the simulation information 304 (or at least power-related information thereof) into moving average data 308, such as for consecutive sets comprising K testcases, where K is a positive integer greater than or equal to 1. K can be selected based on the number of expected testcases used to generate the simulation information 304. The function 306 also can include a sorting function 310 to arrange (or order) the simulation information for a plurality of respective testcases to facilitate convergence. For example, the sorting 310 can be utilized to arrange the data from low to high or from high to low. The sorting further can be implemented based on the estimated power associated with a set of respective testcases. The moving average data 308, which may be sorted, thus can be employed to initialize the Bayesian model 302 to facilitate convergence of the Bayesian estimation. While the moving average function 306 is depicted as part of the model 302, it is to be appreciated that the data preparation implemented thereby could be implemented external to the model.

The Bayesian model 302 determines estimated mean and standard deviation parameters 312 and 314, respectively, based on the power-related simulation information 304 provided to the model 302. In this example, the model 302 includes a Bayesian mean estimator 316 that derives an estimated mean parameter based on the moving average data 308 over a plurality of testcases. In particular, the mean estimator 316 employs an asymptotic function 318 that facilitates convergence of the estimated mean 312, such as by fitting the mean parameters estimated over a plurality of testcases to an asymptotic curve. For example, the asymptotic function can be applied to estimates derived from a selected number of testcases, such as corresponding to about ten percent of the expected number of total testcases.

By way of example, the asymptotic function 318 (hᵢ taken as i→∞) modifies an intermediate estimate of the mean to provide the estimated mean parameter 312. For example, the asymptotic function 318 is operative to predict an infinite saturation point μ₀ associated with the estimated mean parameters determined over plural testcases. The asymptotic function 318 is applied to fit moving average data points generated by the Bayesian estimator to a corresponding asymptotic curve defined by the function. For example, the asymptotic function 318 can be defined as follows:

$${h}_{i} = β + \frac{α}{i} \qquad Eq . 42$$

where β and α are the least square estimates for fitting hᵢ to the estimated moving average data points.

It will be appreciated that as i→∞, hᵢ approaches β. Accordingly, α can either by positive or negative, which generally depends on the fitting process for the moving average values. When α is positive, hᵢ is decreasing. On the other hand, if α is negative, hᵢ is increasing, which provides flexibility in fitting the moving average of the data points. The curve fitting further by hᵢ further can be facilitated by the sorting 310, which can be implemented by the moving average function 306. The sorting of the data points (e.g., simulation information for each respective testcase) mitigates fluctuations from the moving average data points that are utilized by the curve fitting function hᵢ. Those skilled in the art will understand processes or techniques other than least squares that can be utilized to fit the moving average data points to a corresponding asymptotic function. For example, the asymptotic function 318 could employ an expectation-maximization algorithm or regression analysis techniques.

The Bayesian model 302 includes a standard deviation estimator 320 that derives the estimated standard deviation parameter 314 based on the estimated mean parameter 312. As described herein, for example, the estimated mean and standard deviation parameters 312 and 314 can include estimates of switching activities, such as activity factor values, for one or more respective unit of a given circuit design.

A power calculator 322 computes estimated power, respectively, based on circuit-related data 324 (e.g., C_{LOAD}, V_{DD}, and f_{clk}) and the asymptotic Bayesian estimates 312 and 314. For example, the power calculator 322 provides an indication average unit-power (P_{μ}) 326 and corresponding standard deviation unit power estimates (P_{σ}) 328 based on the respective Bayesian estimates 312 and 314 and the circuit-related data 324 (e.g., see Eq. 40). For purposes of illustration only, a collection of the mean and standard deviation unit power estimates 326 and 328 are depicted at 330 and 332, respectively.

An aggregator 334 provides a total average power (TOTAL P_{AVG}) 336 and a total maximum power (TOTAL P_{MAX}) 338 for the circuit design or a selected portion thereof. The aggregator 334 computes the total average power 336 by summing the mean unit power estimates 330. The aggregator 334 provides the total maximum power 338 by summing the standard deviation unit power estimates 332 and adding the total standard deviation power (e.g., at a sigma value to provide a desired confidence level) to the total average power 336.

The power estimation system 300 can also include an evaluator 340 to evaluate the estimation results and/or the Bayesian estimation process. For example, the evaluator 340 can ascertain whether the average power 326 or 336 has adequately saturated or converged to an associated infinite saturation point. Alternatively or additionally, the evaluator 340 can evaluate convergence respective mean parameters 312. Once adequate conversion has been reached, the average power estimates 336, 338 can be deemed substantially accurate. Those skilled in the art will appreciate other techniques that can be employed to evaluate and/or score the parameters estimated by the power estimation system 300.

Even after the evaluator 340 determines that the estimated power parameters have adequately converged (e.g., based on predetermined convergence criterion), the power estimation can continue, as a greater number of testcases should still improve the power estimation results. For example, the power estimation system 300 can be implemented in parallel and concurrently with the simulation that provides the information 304. Accordingly, the system 300 can be utilized to estimate power for so long as the simulation is being implemented on a given circuit design. As mentioned above, for example, functional verification can continue well into the design and layout stages of many circuits, such as microprocessors or other VLSI designs.

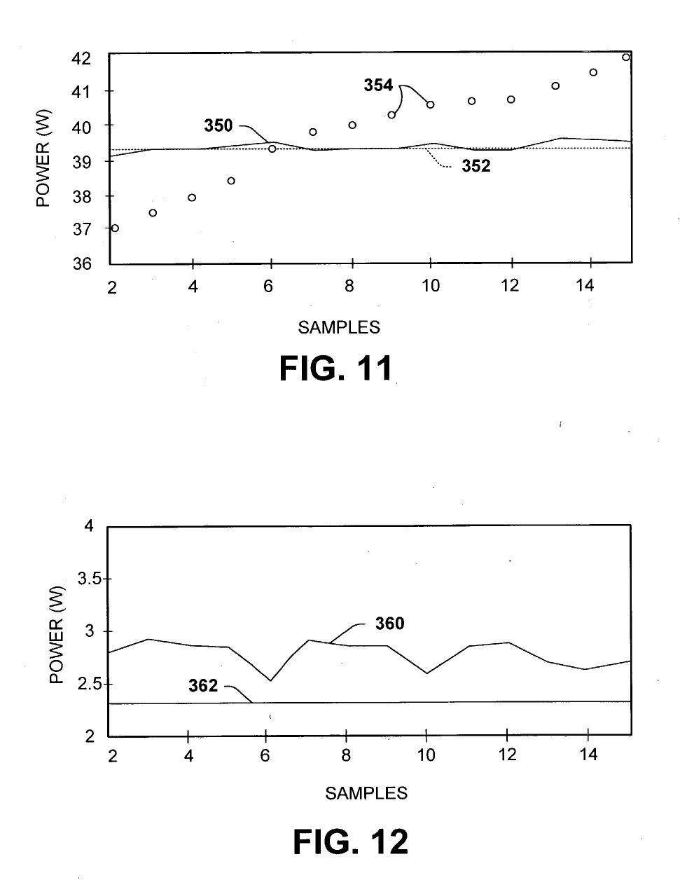

FIGS. 11, 12, 13 and 14 depict comparative examples of power estimates that can be determined by implementing an asymptotic Bayesian power estimation system in accordance with an aspect of the present invention relative to estimated power obtained by other approaches.

FIGS. 11 and 12 illustrate power as a function of samples in which the estimations are determined with different initial guess values selected among the data set. In FIG. 11, a mean power estimate 350 corresponds to an asymptotic Bayesian estimated mean. A simple average estimation for the same set of testcases is indicated as a dotted line at 352. Additionally, sorted data for the testcases utilized to determine the asymptotic Bayesian estimate 350 is indicated at 354. On average, the estimated mean 350 is about 39.4 W, whereas the simple estimation provided a mean 352 of about 39.3 W.

FIG. 12 illustrates the associated standard deviation 360 associated with the asymptotic Bayesian estimate 350 (FIG. 11) as well as a corresponding simple average standard deviation 362 associated with the simple average estimate 352 of FIG. 11. As depicted in FIG. 12, the standard deviation 360 estimated by employing an asymptotic Bayesian process is about 2.8 W, which is about 20% higher than the simple estimated standard deviation 362 of about 2.3 W. This demonstrates that approximately a 20% greater confidence in the asymptotic Bayesian power estimation than the simple average estimation.

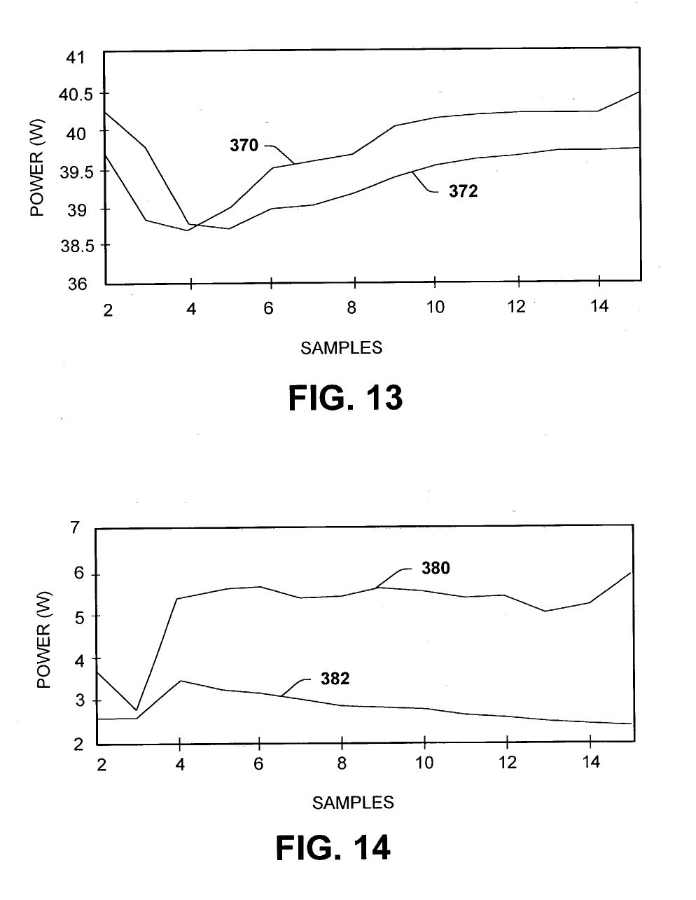

FIGS. 13 and 14 show the behavior of asymptotic Bayesian estimated power relative to corresponding moving average estimates on the same sample data sets. The examples of FIGS. 13 and 14 have been implemented on shorter data sets than the examples described above with respect to FIGS. 13 and 14 in an effort to demonstrate the utility of the asymptotic Bayesian approach for a smaller number of testcases. By a shorter data set it is meant that the initial guesses for the estimation are implemented on a smaller sample size, such as when an ample input space does not yet exist or has not been sufficiently developed (e.g., simulation information has been generated for only a small number of testcases). That is, not enough data points may be available for implementing a moving average function.

In FIG. 13, a mean power estimate 370 has been computed by employing asymptotic Bayesian with a model for the fifteen data points in the history. The mean estimate 370 has been computed to be about 40.5 W. Also depicted in FIG. 13 is a corresponding moving average estimate of mean power, indicated at 372. From FIG. 13, it is shown that the asymptotic Bayesian estimated mean 370 is higher than the simple moving average 372 over a significant portion of the samples (e.g. after the fourth sample testcase).

Additionally, as illustrated in FIG. 14, the asymptotic Bayesian estimation approach to power estimation provides a wide range of confidence. For example, the asymptotic Bayesian approach provided a standard deviation estimate, indicated at 380 of about 5.9 W. In contrast, the simple moving average approach provided a standard deviation estimate, indicated at 382, of about 2.3 W. It is to be appreciated that, unlike the behavior associated with the simple estimation method, the asymptotic Bayesian approach demonstrates stability in estimation even with shorter data sets.

For example, where only four or five more data points have been generated in the estimation process, the estimation for the standard deviation 380 begins to settle around 5.5 W. Thus, the asymptotic Bayesian model shows improved accuracy with a better trend of approaching real silicon measured power consumption during the end of the estimation process when using the moving average data. This result is due, at least in part, to the use of the asymptotic function 318 (FIG. 10) as heuristics for guiding the estimation process. Additionally, both average and maximum power consumption, in a statistical sense, can be obtained in a single flow of power with estimation the asymptotic Bayesian approach implemented according to an aspect of the present invention.

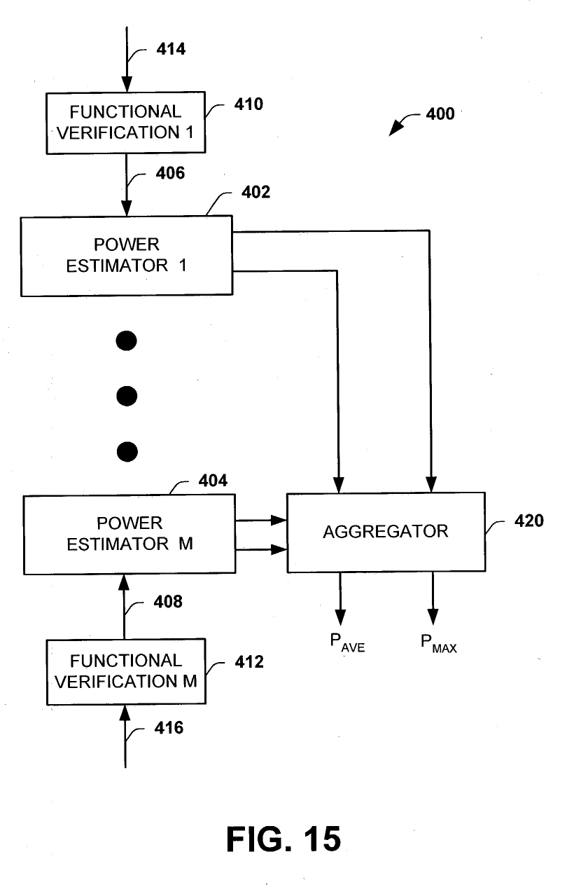

FIG. 15 is an example of a system 400 that can be implemented to estimate power for a plurality of units that collectively form a circuit design or a substantial portion thereof. In this example, M power estimators 402-404 are associated with respective units of the circuit design, where M is a positive integer greater than or equal to one indicative of the number of units. The different units of the circuit design can correspond to distinct functional and/or structural blocks of the design, as described herein. The power estimators 402 and 404 compute power estimates based on simulation information (e.g., testcase results) 406 and 408, respectively. The information 406 and 408, for example, is provided by performing simulations 410 and 412 on the respective units of circuit, such as based on respective input vectors 414 and 416. The respective sets of input vectors 414 and 416 can be utilized to verify functional and/or structural operation of the circuit design.

It is to be understood and appreciated that the simulations 410 and 412 can correspond to different types of simulations and/or employ different simulation tools on the respective units of the circuit. For example, different simulation tools can be employed where different units of the circuit design are at different design stages (e.g., one being at the gate level and another at the transistor level). Additionally, where one unit of the design converges to a final layout more rapidly than others, the simulations for such unit can be reduced or terminated altogether to better focus resources on other units. In this way, different amounts of simulation can be implemented on different circuit units throughout the design process. While distinct simulations 410-412 have been depicted as being implemented for respective input vectors 414 and 416, it is to be appreciated that common input vectors and simulations could be used for all or a portion of the M power estimators 402-404.

The power estimators 402 and 404 are programmed and/or configured to estimate power based on the simulation information 406 and 408 associated with respective circuit units. It is to be understood that the power estimators 402-404 can estimate power using models according to any of the implementations shown and described herein. The power estimators 402 and 404 provide the power estimates, which can include a total average unit power and total standard deviation unit power for the associated circuit units, to an aggregator 420. The aggregator 420 can sum the total average unit power estimates to provide total chip average power P_{AVG}. The standard deviation of the average power consumption of the whole chip is related to the sum of the variances of the average powers of the units, which can be expressed, as follows:

$$chip {σ}_{0}^{2} = {\sum }_{i = 1}^{M} {τ}_{i}^{2} \qquad Eq . 43$$

where M is the number of testcases and τ is the standard deviation for each respective unit.

Thus, the aggregator 420 can determine the total chip standard deviation from the unit power standard deviations provided by the respective power estimators 402 and 404. The total chip standard deviation power (e.g., having a sigma value to provide a desired confidence level) further can be added to the total chip average power P_{AVG} to discern a total chip maximum power P_{MAX}.

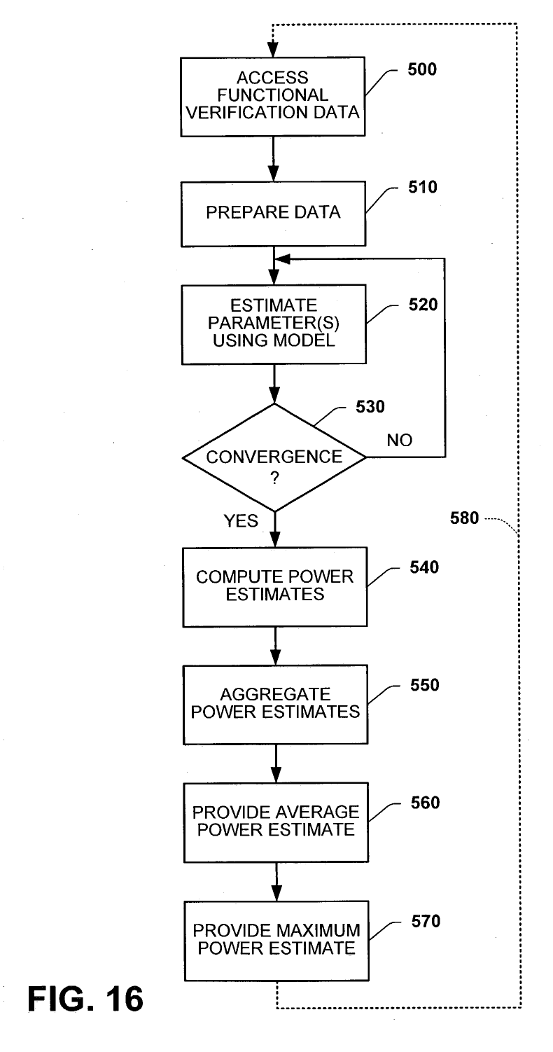

In view of the foregoing structural and functional features described above, a methodology for estimating power, in accordance with an aspect of the present invention, will be better appreciated with reference to FIG. 16. While, for purposes of simplicity of explanation, the methodology of FIG. 16 is shown and described as being implemented serially, it is to be understood and appreciated that the present invention is not limited to the illustrated order, as some aspects could, in accordance with the present invention, occur in different orders and/or concurrently with other aspects from that shown and described. Moreover, not all illustrated features may be required to implement a methodology in accordance with an aspect of the present invention. It is to be further understood that the following methodology can be implemented in hardware, software, or any combination thereof.

The methodology begins at 500 in which simulation data is accessed, which can be located locally or remotely relative to where the methodology is being implemented. For example, the data includes power-related data derived from simulation (e.g., employing functional or structural verification) of a given circuit design or a selected portion thereof based on testcases. Each testcase employs a plurality of input vectors for exercising a circuit design or units thereof. The circuit design can be defined by a circuit model, such as a RTL model or other type of circuit description. The model can be generated by any suitable CAD tool. The data provided at 500 can be generated by functional verification running in parallel and concurrently with the methodology of FIG. 16 or, alternatively, the simulation data can be obtained from a database or other data structure that stores such data. By using functional verification data, according to one particular implementation, no specific simulations or power-related input vectors need be developed.

At 510, the simulation data is prepared, such as to facilitate subsequent analysis and computations. For example, the data preparation can include ascertaining power-related values (e.g., activity factors) based on the information accessed at 500. Additionally, data can be prepared by sorting and/or computing moving averages for a number samples to mitigate fluctuations from the sample order. A moving average function also can be applied to the functional verification data, such as to facilitate convergence of the estimations to be determined. Other types of data preparation or data conversion can be utilized to facilitate power estimation. It is to be further appreciated that the data preparation implemented at 510 is optional, as subsequent portions of the methodology can be implemented in the absence of data preparation.

At 520, one or more power-related parameters are estimated using a statistical model. The power-related parameter, for example, can include switching activity characteristics, such as the activity factor data derived from the functional verification data provided at 500. The power-related parameters can include an indication of switching activities at any unit-level of an associated circuit design. In one particular example, the power-related parameter corresponds to the mean and standard deviation power for node-level switching characteristics, such as the activity factor. The granularity of such power-related parameters will depend on the type of circuit model and the particular circuit level description being utilized.

Additionally, those skilled in the art will understand and appreciate various types of statistical models that can be employed at 520 to estimate the parameters. A particular model can be selected according to the type of simulation implemented to provide the simulation data (at 500). For example, the statistical model can be implemented using moving average statistics. Alternatively, a Bayesian model could be utilized to estimate power-related parameters, which can be a simple Bayesian model or an asymptotic Bayesian model, as described herein. It is to be appreciated that these and other models that map to corresponding distribution functions can be efficiently employed to determine both mean and standard deviation power-related parameters using common functional verification testcases (see, e.g., Eq. 40), which can be utilized to further compute average and maximum power estimates, respectively, as described herein. By employing a proper statistical model, the mean and standard deviation parameters can be derived concurrently by the model to facilitate average and maximum power computations, as described herein.

At 530, a determination is made as to whether the estimated parameters converge. The convergence can be determined based on substantially any convergence criteria. For example, convergence can be ascertained based on a subset of the most recent estimated parameters being within a predetermined threshold of each other. Alternatively, the parameters estimated at 520 can be fit to an asymptotic function that converges at a mean value for the respective parameter as the number of samples approaches infinity. The curve fitting, for example, can be implemented by employing least square estimates or other curve fitting techniques. If the determination at 530 indicates there is not adequate convergence, the methodology returns to 520 and statistical estimations are performed for additional testcases. If convergence has been achieved, however, the methodology proceeds to 540.

At 540, the power estimates are computed based on the model parameters estimated at 520. For the example where the estimated parameters corresponds to unit-level activity factors for the circuit design, mean unit power can be computed as a function of the estimated mean activity factor, C_{LOAD}, f_{CLK} and V_{DD} associated with respective units of the design. Additionally, a standard deviation power can also be computed based on the estimated mean power, which standard deviation corresponds to a maximum power estimate for each respective unit. In particular, maximum power for a given circuit unit corresponds to the unit mean power plus the standard deviation unit power for that circuit unit.

At 550, the power estimates at 540 are aggregated. For example, mean unit power estimates can be added together to provide a total average power estimate provided at 560 for the circuit design or a selected portion thereof. Additionally, the standard deviation unit power estimates can be added together to ascertain a total estimated power standard deviation. The total power standard deviation is added to the total average power estimate provided at 560 to provide a total maximum power estimate at 570.

It is to be appreciated that the foregoing methodology at 500-570 can be repeated continually (indicated by dashed line at 580) as additional simulation results are generated for a given circuit design. In this way, as simulations are run for a greater number of testcases, more accurate average and maximum power estimates provided at 560 and 570 can be achieved. Accordingly, the methodology is particularly effective for complex circuit designs, such as microprocessors, in which simulations (e.g., functional verification) are routinely and consistently implemented throughout various stages of the design process to ensure proper operation of the circuit and improve design convergence. Advantageously, the above methodology can provide good approximations of both average and maximum power based on a common set of testcases. Accordingly, by using functional verification results (or other types of simulation already being generated for verifying different functional or structural features of circuit operation), no specialized power simulation tool is required and it becomes unnecessary to design specific input vectors for power estimation.

What has been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A power estimation system, comprising:
a Bayesian model that estimates at least one parameter indicative of power associated with at least one power consuming unit based on simulation data generated by performing simulation for the at least one unit over a plurality of testcases; and
a power calculator that computes estimated power based on the estimated at least one parameter.

2. The system of claim 1, further comprising a moving average function associated with the Bayesian model to determine a moving average for the at least one parameter over a number of the plurality of testcases, the Bayesian model employing the moving average for the at least one parameter to facilitate convergence of the at least one parameter being estimated by the Bayesian model.

3. The system of claim 2, the Bayesian model employs an associated asymptotic function and fits the estimated at least one parameter to the asymptotic function to facilitate convergence of the at least one parameter being estimated by the Bayesian model.

4. The system of claim 1, the power calculator computes a mean power estimate and a standard deviation power estimate based on the estimated at least one parameter, the mean and standard deviation power estimates being determined for the at least one unit, the at least one unit corresponding to at least a portion of a circuit design on which the simulation is performed.

5. The system of claim 4, further comprising an aggregator that employs mean unit power estimates to provide an indication of a total estimated average power or a part of the circuit design corresponding to a plurality of respective units and employs standard deviation unit power estimates to provide a total estimated maximum power for the part of the circuit design corresponding to the plurality of respective units, the Bayesian model providing the respective mean and standard deviation unit power estimates for the plurality of respective units of the circuit design.

6. The system of claim 1, the Bayesian model determines estimated mean and standard deviation parameters for a plurality of respective units of a circuit design based on the simulation data generated over the plurality of testcases for at least a portion of the circuit design, the power calculator computes mean power estimates based on the estimated mean parameters determined by the model and computes standard deviation power estimates based on the estimated standard deviation parameters determined by the model.

7. The system of claim 6, the simulation data being generated from functional verification of at least a portion of the circuit design over the plurality of testcases, the both the mean power estimate and the standard deviation power estimate being determined from a common set of the plurality of testcases.

8. The system of claim 1, further comprising a model evaluator that controls application of the Bayesian model relative to the simulation data based on a convergence criterion.

9. The system of claim 1, the Bayesian model further comprising:
a first estimator that determines an estimated mean parameter indicative of power associated with the at least one unit, which at least one unit defines part of a circuit design;
a second estimator that that determines an estimated standard deviation parameter indicative of power associated with the at least one unit, and
an average power estimate for at least a portion of the circuit design being determined based on the estimated mean parameter and a maximum power estimate being determined based on the average power estimate and the estimated standard deviation parameter.

10. The system of claim 1, the at least one parameter characterizes a power-related switching activity associated with the at least one unit of a circuit on which the simulation is performed.

11. The system of claim 1, the Bayesian model estimates the at least one parameter as a node-level activity factor for a plurality of respective nodes of a circuit design on which the simulation is performed over the plurality of testcases, the power calculator computes estimated power associated with the plurality of respective nodes based on the node-level activity factor estimated by the Bayesian model for the plurality of respective nodes.

12. The system of claim 1, the power calculator computes the estimated power for a plurality of respective units of a circuit design on which the simulation is performed over the plurality of testcases based on the estimated at least one parameter and predetermined circuit-related data associated with the plural respective units of the circuit design.

13. The system of claim 1, the simulation data including switching activity information derived from functional verification of a circuit model that represents a circuit on which the simulation is performed, and a set of input vectors defining a testcase applied to exercise at least a portion of the circuit model and generate functional verification data over the plurality of testcases, the Bayesian model estimates the at least one parameter based on the functional verification data.

14. The system of claim 13, the circuit model comprising a register transfer level model for at least a portion of the circuit, the functional verification data including switching activity information that characterizes node-level switching activities in the register transfer level model.

15. A power estimation system, comprising:
a power estimator that employs a Bayesian model to determine an indication of power for at least one unit of a circuit based on simulation data generated over a plurality of testcases for at least a portion of the circuit that includes the at least one unit; and
the simulation data for each of the plurality of testcases describing activity of the at least one unit of the circuit according a plurality of input vectors designed to exercise the at least the portion the circuit.

16. The system of claim 15, the power estimator determines an indication of average power and maximum power for the at least one unit of the circuit, the average and maximum power being determined based on power-related information derived from the simulation data generated over a plurality of testcases.

17. The system of claim 15, the Bayesian model estimates at least one power-related parameter based on activity of the at least one unit derived from the simulation data for each of the plurality of testcases.

18. The system of claim 17, the estimated at least one power-related parameter further comprising an estimated mean parameter and an estimated standard deviation parameter associated with an activity factor for the at least one unit of the circuit.

19. The system of claim 18, the power estimator determines an indication of average power based on the estimated mean parameter for a plurality of respective units of the circuit and determines an indication of maximum power based on the indication of average power and the estimated standard deviation parameter for the plurality of respective units of the circuit.

20. The system of claim 15, further comprising an aggregator that aggregates an indication of mean unit power for a plurality of respective units of the circuit to provide an indication of total average power associated with the respective units of the circuit, and aggregates an indication of standard deviation unit power for the plurality of respective units of the circuit to provide a total standard deviation power that is added to the indication of total average power to provide an indication of total maximum power for the respective units of the circuit,
the power estimator employing the Bayesian model to determine the indication of mean unit power for the plurality of respective units of the circuit and to determine the indication of standard deviation power for the plurality of respective units of the circuit.

21. The system of claim 15, the power estimator further comprising a plurality of power estimators, each of the plurality of power estimators being associated with a respective unit of the circuit and operative to determine an indication of power for at least one associated respective unit of the circuit based on the simulation data generated over the plurality of testcases.

22. The system of claim 21, each of the plurality of power estimators comprising a Bayesian model that determines an estimated mean parameter and an estimated standard deviation parameter associated with a switching activity factor estimated for the at least one associated respective unit of the circuit.

23. The system of claim 15, the simulation data including switching activity information derived from functional verification of a circuit model that represents a circuit design on which the simulation is performed over the plurality of testcases, and a set of input vectors defining a testcase being applied to exercise at least a portion of the circuit model and generate functional verification data over the plurality of testcases.

24. The system of claim 15, further comprising an associated asymptotic function, the estimated at least one parameter being fit to the asymptotic function for a number of the plurality of testcases to facilitate convergence of the at least one parameter being estimated by the model.

25. A power estimation system, comprising:
Bayesian means for modeling at least one power-related parameter associated with a circuit design based on simulation data generated over a plurality of testcases; and
means for computing a power estimate based at least in part on the modeled at least one parameter.

26. The power estimation system of claim 25, the Bayesian means further comprising:
means for estimating a first power-related parameter based on the simulation data generated over a plurality of testcases; and
means for estimating a second power-related parameter based at least in part on the first power related parameter.

27. The power estimation system of claim 26, the means for computing further comprising:
means for computing a first power characteristic for the circuit design based on associated circuit-related data and the estimated first power related parameter; and
means for computing a second power characteristic for the circuit design based on the first power characteristic and the estimated second power-related parameter.

28. The power estimation system of claim 25, further comprising:
unit Bayesian means for modeling at least one power-related parameter for each associated one of a plurality of units of the circuit design based on the simulation data generated over the plurality of testcases; and
means for computing an aggregate power estimate for the plurality of units based at least in part on the at least one parameter modeled by the unit Bayesian means associated with each of the respective plurality of units.

29. The power estimation system of claim 25, further comprising means for accessing the simulation data, the simulation data comprising functional verification data generated based on a set of input vectors applied to exercise at least a portion of the circuit design, each of the plurality of testcases being associated with a respective set of input vectors.

30. The power estimation system of claim 25, further comprising means for fitting the at least one parameter to an asymptotic function over a number of testcases to facilitate convergence of the at least one parameter being estimated by the Bayesian model.

31. A power estimation method for a circuit design, comprising:
accessing simulation data generated for the circuit design based on at least one set of input vectors that defines a testcase; and
employing a Bayesian model to estimate an indication of power for at least one unit of the circuit design based on the simulation data generated over a plurality of testcases.

32. The method of claim 31, further comprising determining a moving average associated with the estimated indication of power over a number of the plurality of testcases to facilitate convergence of the at least one parameter being estimated by the Bayesian model.

33. The system of claim 31, fitting the estimated indication of power to an associated asymptotic function over a number of the plurality of testcases to facilitate convergence of the at least one parameter being estimated by the Bayesian model.

34. The method of claim 31, further comprising:
estimating an indication of unit power for each of a plurality of respective units of the circuit design; and
aggregating the respective indications of unit power to provide an aggregate indication of power for that portion of the circuit design associated with the plurality of respective units.

35. The method of claim 31, the estimated indication of power comprising an estimated mean parameter and an estimated standard deviation parameter indicative of an activity factor for the at least one unit of the circuit design.

36. The method of claim 31, further comprising fitting the estimated indication of power to an asymptotic function to facilitate convergence of the indication of power being estimated by the Bayesian model.

37. A computer-readable medium having computer-executable instructions for performing the method of claim 31.
